(19) United States
(12) Patent Application Publication
(10) Pub. No.: US 2011/0205968 A1
(43) Pub. Date: Aug. 25, 2011

(54) Method and apparatus for performing sounding in wireless communication system

(75) Inventors: Yun-Joo KIM, Suwon (KR); Sok-Kyu LEE, Daejeon (KR); Hyun-Kyu CHUNG, Daejeon (KR)

(73) Assignee: Electronics and Telecommunications Research Institute, Daejeon (KR)

(21) Appl. No.: 13/032,369

(22) Filed: Feb. 22, 2011

(30) Foreign Application Priority Data
Feb. 22, 2010 (KR) 10-2010-0015534

(51) Int. Cl. H04W 4/00

(52) U.S. Cl. 370/328

(57) ABSTRACT

A sounding method of a transmitting terminal that transmits data to two or more receiving terminals in a wireless communication system includes transmitting a frame for requesting transmission of first sounding information to the two or more receiving terminals, receiving a frame including the first sounding information from each of the two or more receiving terminals, transmitting a frame including information for requesting transmission of channel state information and second sounding information to the two or more receiving terminals, and receiving a frame including the channel state information, which is measured by each of the two or more receiving terminals by using the second sounding information, from each of the two or more receiving terminals, wherein the channel state information measured by using the first sounding information and the channel state information received from each of the two or more receiving terminals are used to simultaneously transmit the data to the two or more receiving terminals.

### CROSS-REFERENCE(S) TO RELATED APPLICATIONS

The present application claims priority of Korean Patent Application No. 10-2010-0015534, filed on Feb. 22, 2010, which is incorporated herein by reference in its entirety.

### BACKGROUND OF THE INVENTION

1. Field of the Invention

Exemplary embodiments of the present invention relate to a method and apparatus for performing sounding in a wireless communication system; and, more particularly, to a method and apparatus for performing sounding in a wireless communication system that transmits data to multiple users simultaneously.

2. Description of Related Art

The throughput of wireless communication systems is not high enough to support various high-capacity multimedia services. Since multiple users share wireless resources, the data rate of wireless services, sensed by the users, decreases remarkably. In order to support smooth wireless multimedia services, the IEEE 802.11n defines high-performance wireless LAN techniques supporting a physical (PHY) rate of more than 600 Mbps. The IEEE 802.11ac specifies that a data rate of up to 1 Gbps must be supported by a MAC (Medium Access Control) SAP (Service Access Point) of an AP (Access Point) in a wireless communication system including one AP and two stations (STAs) and a data rate of up to 500 Mbps must be supported by a MAC SAP of an STA for a point-to-point environment, in order to configure a high-rate wireless communication system.

To this end, research is conducted on various techniques to improve the throughput of a wireless communication system for multiple users by increasing the bandwidth to expand wireless resources shared by multiple users or by implementing a desired beam for communication with each user while using wireless resources of the same bandwidth. Instead of increasing the throughput by increasing the bandwidth, an MU-MIMO (Multi-User Multi Input Multi Output) technique supports the throughput of a wireless LAN system by transmitting data by forming a beam on the basis of a channel environment between each user (STA) and an AP within a limited bandwidth.

In order to support an efficient MU-MIMO service, each STA and an AP constituting a wireless LAN BSS (Basic Service Set) must accurately know channel state information (CSI) about a data communication target.

What is therefore required is a method for obtaining CSI about each user to provide a high throughput when simultaneously transmitting data to multiple users in wireless communication systems by using various techniques including the MU-MIMO technique.

### SUMMARY OF THE INVENTION

An embodiment of the present invention is directed to a method and apparatus for performing sounding in a wireless communication system that simultaneously transmits data to multiple users, which can obtain channel state information (CSI) about each user to provide a high throughput.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a sounding method of a transmitting terminal that is to simultaneously transmit data to two or more receiving terminals in a wireless communication system includes: transmitting a frame for requesting transmission of first sounding information to the two or more receiving terminals; receiving a frame including the first sounding information from each of the two or more receiving terminals; transmitting a frame including information for requesting transmission of channel state information and second sounding information to the two or more receiving terminals; and receiving a frame including the channel state information, which is measured by each of the two or more receiving terminals by using the second sounding information, from each of the two or more receiving terminals, wherein the channel state information measured by using the first sounding information and the channel state information received from each of the two or more receiving terminals are used to simultaneously transmit the data to the two or more receiving terminals.

In accordance with another embodiment of the present invention, a sounding method of a receiving terminal that receives data from a transmitting terminal that is to simultaneously transmit data to two or more receiving terminals in a wireless communication system includes: receiving a frame for requesting transmission of first sounding information from the transmitting terminal; transmitting a frame including the first sounding information to the transmitting terminal; receiving a frame including information for requesting transmission of channel state information and second sounding information from the transmitting terminal; and transmitting a frame including the channel state information, which is measured by using the received second sounding information, to the transmitting terminal, wherein the channel state information measured by the transmitting terminal by using the first sounding information and the channel state information measured by using the second sounding information are used to simultaneously transmit the data from the transmitting terminal to the two or more receiving terminals.

In accordance with another embodiment of the present invention, a sounding method of a transmitting terminal that is to simultaneously transmit data to two or more receiving terminals in a wireless communication system includes: transmitting a frame including information for requesting transmission of channel state information and sounding information to the two or more receiving terminals; and receiving a frame including the channel state information, which is measured by each of the two or more receiving terminals by using the sounding information, from each of the two or more receiving terminals, wherein the channel state information received from each of the two or more receiving terminals is used to simultaneously transmit the data to the two or more receiving terminals.

In accordance with another embodiment of the present invention, a sounding method of a receiving terminal that receives data from a transmitting terminal that is to simultaneously transmit data to two or more receiving terminals in a wireless communication system includes: receiving a frame including information for requesting transmission of channel state information and sounding information from the transmitting terminal; and transmitting a frame including the channel state information, which is measured by using the received sounding information, to the transmitting terminal, wherein the channel state information measured by using the received sounding information is used to simultaneously transmit the data from the transmitting terminal to the two or more receiving terminals.

In accordance with another embodiment of the present invention, a transmitting terminal for performing sounding to simultaneously transmit data to two or more receiving terminals in a wireless communication system includes: a transmitting unit configured to transmit a frame for requesting transmission of first sounding information to the two or more receiving terminals; and a receiving unit configured to receive a frame including the first sounding information from each of the two or more receiving terminals, wherein the transmitting unit transmits a frame including information for requesting transmission of channel state information and second sounding information to the two or more receiving terminals; the receiving unit receives a frame including the channel state information, which is measured by each of the two or more receiving terminals by using the second sounding information, from each of the two or more receiving terminals; and the channel state information measured by using the first sounding information and the channel state information received from each of the two or more receiving terminals are used to simultaneously transmit the data to the two or more receiving terminals.

In accordance with another embodiment of the present invention, a receiving terminal for performing sounding to receive data from a transmitting terminal that is to simultaneously transmit data to two or more receiving terminals in a wireless communication system includes: a receiving unit configured to receive a frame for requesting transmission of first sounding information from the transmitting terminal; and a transmitting unit configured to transmit a frame including the first sounding information to the transmitting terminal, wherein the receiving unit receives a frame including information for requesting transmission of channel state information and second sounding information from the transmitting terminal; the transmitting unit transmits a frame including the channel state information, which is measured by using the received second sounding information, to the transmitting terminal; and the channel state information measured by the transmitting terminal by using the first sounding information and the channel state information measured by using the second sounding information are used to simultaneously transmit the data from the transmitting terminal to the two or more receiving terminals.

### BRIEF DESCRIPTION OF THE DRAWINGS

FIG. 1 is a diagram illustrating a frame exchange sequence for transmission of a null data packet (NDP).

FIG. 2 is a diagram illustrating channels between a transmitter and a receiver.

FIG. 3 is a diagram illustrating a calibration exchange for implicit feedback.

FIG. 4 is a diagram illustrating a process of transmitting beamformed data by implicit feedback and explicit feedback.

FIG. 5 is a diagram illustrating a sounding method in accordance with an exemplary embodiment of the present invention.

FIG. 6 is a diagram illustrating a CTS/ACK frame structure defined in the IEEE 802.11.

FIG. 7 is a diagram illustrating a response frame structure in accordance with an exemplary embodiment of the present invention.

FIG. 8 is a diagram illustrating the use of an ACK frame including sounding information in accordance with an exemplary embodiment of the present invention.

FIG. 9 is a diagram illustrating the use of an ACK frame including channel state information (CSI) in accordance with an exemplary embodiment of the present invention.

FIG. 10 is a diagram illustrating the use of a CTS frame including channel state information (CSI) in accordance with an exemplary embodiment of the present invention.

FIG. 11 is a diagram illustrating a sounding method for broadcasting a frame including TRQ information in accordance with an exemplary embodiment of the present invention.

FIG. 12 is a diagram illustrating a sounding method for broadcasting a frame including TRQ information in accordance with another exemplary embodiment of the present invention.

FIG. 13 is a block diagram of an access point (AP) or a station (STA) in accordance with an exemplary embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. In the following description, detailed descriptions of well-known functions or configurations will be omitted in order not to unnecessarily obscure the subject matters of the present invention. Throughout the disclosure, like reference numerals refer to like parts throughout the various figures and embodiments of the present invention.

The present invention provides a scheme for obtaining channel state information (CSI) about each user to simultaneously transmit data to multiple users in a wireless communication system.

In this context, a transmit beamforming (TxBF) technique defined on the basis of a MIMO system in the 802.11n will be described below.

A MIMO-TxBF technique defined in the 802.11n draft is to improve the signal-to-noise ratio (SNR) of a receiving (Rx) terminal by controlling a signal (beam) from an antenna. Specifically, the MIMO-TxBF technique improves the SNR of an Rx terminal by maximizing the Rx energy of each spatial stream received from a Tx terminal. To this end, a receiver provides a channel state information (CSI) feedback about an Rx signal to a transmitter. The transmitter/receiver transmits a physical protocol data unit (PPDU) including sounding information (hereinafter referred to as a sounding PPDU) so that the receiver/transmitter can measure CSI. A medium access control (MAC) protocol defined in the 802.11n supports such a sounding process, and particularly supports a sounding protocol that operates in conjunction with a feedback providing method for TxBF.

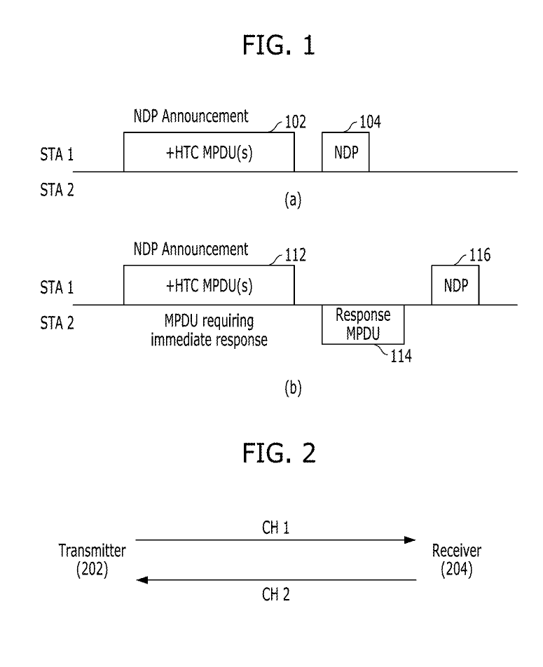

The sounding PPDU may be a staggered PPDU including MAC data, or a null data packet (NDP) not including MAC data. Since the staggered PPDU includes MAC data, it includes receiver/transmitter information. However, since a physical service data unit (PSDU) is null, the previous frame 102 includes NDP announcement information indicating that the next frame is an NDP 104, as illustrated in FIG. 1. That is, although an overhead decreases because the NDP does not transmit data for sounding, the NDP can be used only when a frame exchange sequence is predefined. For example, the frame exchange sequence may be defined in such a way as to transmit a frame 102 including NDP announcement information and then transmit an NDP 104, as illustrated in FIG. 1 (a). Alternatively, the frame exchange sequence may be defined in such a way as to transmit a frame 112 including NDP announcement information, receive a response frame 114 to the frame 112 and then transmit an NDP 116, as illustrated in FIG. 1 (b).

TxBF channel feedback transmission methods are classified into an implicit feedback method and an explicit feedback method. Referring to FIG. 2, when a transmitter 202 uses TxBF to transmit data to a receiver 204, the implicit feedback method calculates a TxBF matrix value by the transmitter 202, whereas the explicit feedback method calculates a TxBF matrix value by the receiver 204 and transmits the calculated TxBF matrix value to the transmitter 202. This will be described below in detail. As illustrated in FIG. 2, the transmitter 202 uses a channel CH1 to transmit a frame to the receiver 204, and the receiver 204 uses a channel CH2 to transmit a frame to the transmitter 202. However, the transmitter 202 can obtain information about the channel CH2 from the receiver 204, and the receiver 204 can obtain information about the channel CH1 from the transmitter 204. Herein, the transmitter 202 calculates a beamforming matrix by using the information about the channel CH2 obtained from the receiver 204, and transmits a beamformed PPDU by using the calculated beamforming matrix, which is an implicit feedback method. On the other hand, the receiver 204 calculates a beamforming matrix by using the information about the channel CH1 obtained from the transmitter 202, and provides the calculated beamforming matrix to the transmitter 202, which is an explicit feedback method.

However, if the channel CH1 and the channel CH2 are reciprocal, the implicit feedback method can use the beamforming matrix calculated using the information about the channel CH2 obtained from the receiver 204, but if the channel CH1 and the channel CH2 are not reciprocal, the implicit feedback method requires calibration thereof. That is, a calibration process is an operation performed by the transmitter 202 and the receiver 204 to correct an error generated when the transmitter 202 calculates a beamforming matrix on the basis of information about the channel CH2 in a TxBF implicit feedback process. A sounding operation, such as an NDP and a staggered PPDU, is used by the transmitter 202 to obtain channel information in a calibration or explicit feedback operation with respect to the receiver 204.

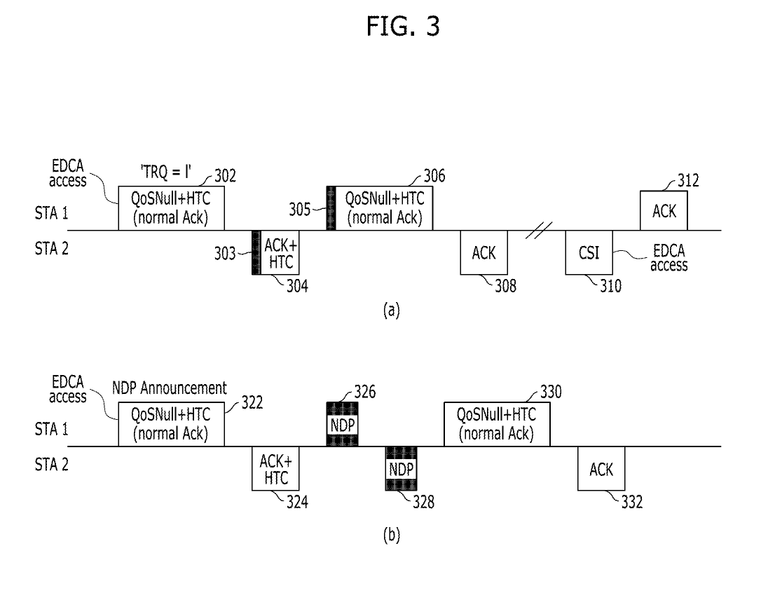

A calibration exchange process for implicit feedback in the process of transmitting data from a transmitter STA1 to a receiver STA2 will be described below with reference to FIG. 3. FIG. 3 (a) illustrates a process of performing sounding by using a staggered PPDU, and FIG. 3 (b) illustrates a sounding process using an NDP.

Referring to FIG. 3 (a), the STA1 transmits a request frame 302 including training request (TRQ) information (e.g., a QoS null data frame including an HT control field) to the STA2. The request frame 302 is to request the STA2 to transmit a sounding PPDU 304, and has a value of ‘1’ at a calibration position as a calibration start frame. The STA2 transmits the sounding PPDU 304 including sounding information 303 to the STA1. Herein, the STA2 may transmit the sounding PPDU 304 (e.g., an ACK frame including an HT control field) having a value of ‘2’ at a calibration position after a short inter-frame space (SIFS) from the reception of the sounding PPDU request frame 302. The sounding information is used by a sounding information receiving terminal to measure channel state information (CSI) of a channel used to transmit the sounding information. For example, the sounding information may be a training symbol necessary to measure channel state information. The channel state information is information indicating a channel state. For example, the channel state information may be information about multipath fading, delay spread, channel correlation, and available channels. A beamforming matrix for beamforming of an MU-MIMO system may be obtained from the channel state information. The STA1 transmits a frame 306, including sounding information 305 and information for requesting CSI (hereinafter referred to as CSI request information), to the STA2. Herein, the STA1 transmits the frame 306 (e.g., a QoS null data frame including an HT control field) indicating the end of the sounding process and having a value of ‘3’ at a calibration position after an SIFS from the reception of the sounding PPDU 304. Upon receiving the frame 306, the STA2 transmits an ACK frame 308 in response to the frame 306, measures CSI of a channel directed from the STA1 to the STA2 by using the received sounding information 305, and transmits a frame 310 including the measured CSI to the STA1 through contention-based enhanced distributed channel access (EDCA). The STA1 transmits an ACK frame 312 in response to the frame 310. The STA1 transmits data to the STA2 by using the CSI measured using the received sounding information 303 and the CSI received from the STA2.

Referring to FIG. 3 (b), the STA1 transmits a frame 322 (e.g., a QoS null data frame including an HT control field), including NDP announcement information announcing transmission of an NDP 326, to the STA2, receives a response frame 324 from the STA2, and transmits NDP 326. The STA2 transmits an NDP 328 as a sounding PPDU after an SIFS from the reception of the NDP 326 from the STA1. Thereafter, frames 330 and 332 perform the same functions as the frames 306 and 308 of FIG. 3 (a), respectively. Thereafter, although not illustrated in FIG. 3 (b), frames 310 and 312 are exchanged as in FIG. 3 (a).

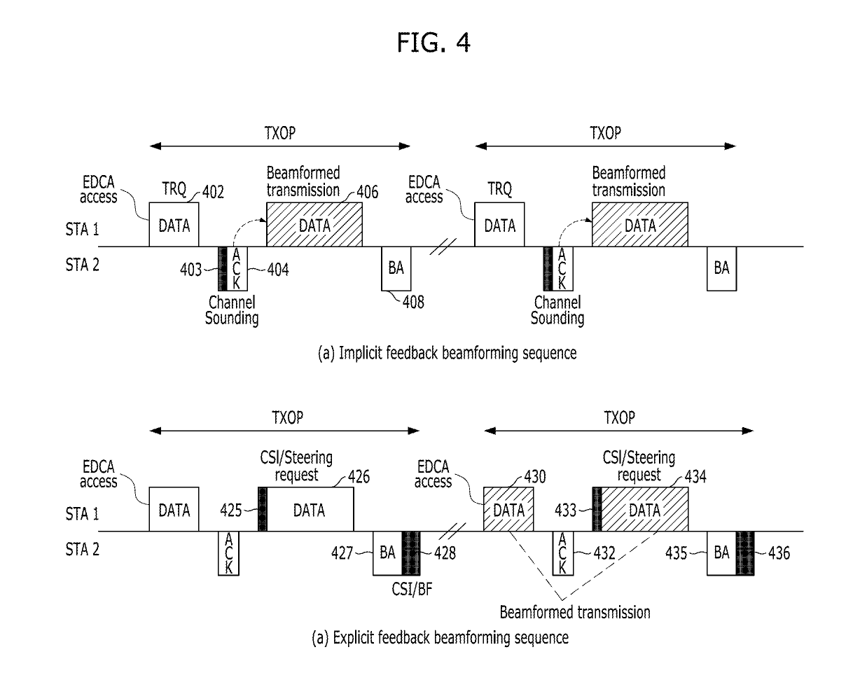

A process of transmitting beamformed data from the STA1 to the STA2 by using an implicit feedback (FIG. 4 (a)) and an explicit feedback (FIG. 4 (b)) will be described below with reference to FIG. 4.

Referring to FIG. 4 (a), the STA1 transmits a frame 402, including TRQ information for channel sounding, to the STA 2. The STA2 transmits a response frame (i.e., a sounding PPDU) 404 of, including sounding information 403, to the STA1. The STA 1 measures channel state information (CSI) by using the received sounding PPDU 404, transmits beamformed data 406 to the STA2 by using the measured CSI, and receives a response frame (e.g., a block ACK (BA)) 408 for the beamformed data 406 from the STA2.

Referring to FIG. 4 (b), the STA1 transmits a frame 426, including sounding information 425 and CSI request information, to the STA2. The STA2 transmits a response frame (e.g., a BA) 427, which piggybacks CSI 428 measured using the received sounding information 425, to the STA1. Herein, the CSI 428 and/or beamforming (BF)-related information (e.g., a TxBF matrix) may be transmitted to the STA1. The STA1 receives the CSI 428 from the STA2, and the received CSI 428 is used to beamform and transmit the next data 430. If a CSI change (e.g., a channel change) is necessary, the STA1 re-transmits a frame 434, including sounding information 433 and CSI request information, to the STA2. The subsequent process is the same as described above.

The beamforming sequences of FIG. 4 are embodiments using a staggered PPDU, and various operations may be performed according to the CSI response methods of an explicit feedback by using an NPD.

In a wireless LAN (WLAN) system defined in the IEEE 802.11, wireless resources are shared on the basis of Carrier Sense Multiple Access/Collision Avoidance (CSMA/CA), and a wireless terminal obtains a channel and transmits data through the obtained channel. Thus, a sounding process is performed according to a predetermined frame exchange sequence such as a 2-way or 3-way handshake. However, an MU-MIMO technique simultaneously transmits beamformed data to multiple users, and to this end, sounding information must be beforehand obtained from the multiple users.

If a sounding process is performed sequentially on the basis of a point-to-point relationship, an overhead for performing this operation in a wireless environment with frequency channel changes may be large. In particular, if there is no information about a transmitter/receiver as in an NDP, a sounding operation may not be normally performed. Thus, if a multi-user frame structure and a sounding process performed from multiple users are not efficiently defined, it may degrade the throughput of a wireless communication system that simultaneously transmits data to multiple users.

The present invention provides a method for obtaining CSI about each user, which is necessary to simultaneously transmit data to multiple users, as described above. Data about users may be identical or not. For the sake of convenience, a description is given of a method for transmitting/processing a sounding signal for multiple users in a wireless communication system using an MU-MIMO system based on a wireless communication system defined in the IEEE 802.11. However, the present invention is not limited to the MU-MIMO system. Thus, the present invention can support various wireless environments such as a multi-channel environment and a wireless LAN environment supported by the MU-MIMO system.

The MU-MIMO technique simultaneously transmits beamformed data to multiple users, thereby making it possible to achieve a high throughput with a limited bandwidth. To this end, a sounding process for obtaining CSI about multiple users is required. The present invention provides an effective method for a transmitter to obtain CSI or sounding information from multiple users. For the sake of convenience, a description is given of a method for an AP (transmitter) to obtain CSI or sounding information about one or more STAs (receivers). Thus, the present invention may also be applicable to the case where any STA obtains CSI or sounding information about one or more receivers (APs and/or STAs).

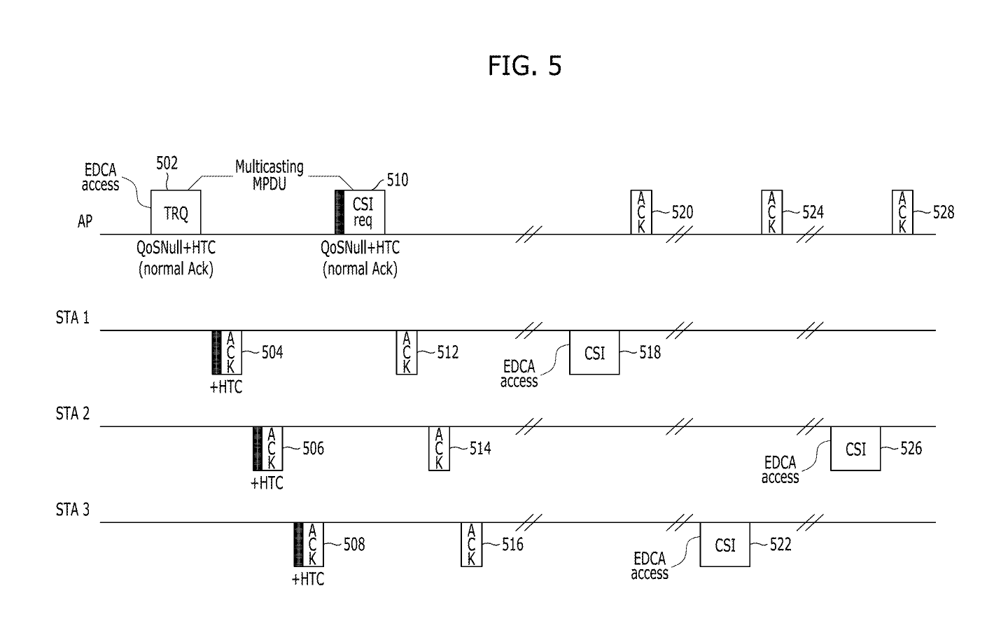

FIG. 5 is a diagram illustrating a sounding process in accordance with an exemplary embodiment of the present invention. A calibration process for implicit feedback illustrated in FIG. 3 is a sounding method necessary for point-to-point communication. FIG. 5 illustrates a method for an AP to obtain CSI or sounding information about multiple users STA1, STA2 and STA3 to simultaneously transmit data to the multiple users STA1, STA2 and STA3.

Referring to FIG. 5, the AP transmits a request frame 502 including TRQ information to the multiple users STA1, STA2 and STA3 to which data will be simultaneously transmitted. The request frame 502 is used to request the multiple users STA1, STA2 and STA3 to transmit a sounding PPDU, and may include scheduled response transmission information which is information about the multiple users STA1, STA2 and STA3 (i.e., receivers). The scheduled response transmission information includes the addresses of the receivers, and may further include the transmission time points of response frames 504, 506 and 508. For example, the request frame 502 may be a QoS null data frame including an HT control field (QoS Null+HTC Frame), may be a normal ACK type, and may have a value of ‘1’ at a calibration position as a calibration start frame.

The user STA1/STA2/STA3 transmits a sounding PPDU 504/506/508 including sounding information (signal) to the AP at the corresponding transmission time point included in the scheduled response transmission information. That is, the AP transmits the request frame 502, and receives the sounding PPDU 504/506/508 at the transmission time point of the user STA1/STA2/STA3 included in the scheduled response transmission information. For example, the AP receives the sounding PPDU 504 of the STA1 after an SIFS, receives the sounding PPDU 506 of the STA2 after the next SIFS, and receives the sounding PPDU 508 of the STA3 after the next SIFS. Herein, since the request frame 502 is a normal ACK type, the sounding PPDU 504/506/508 may be an ACK frame including an HT control field (ACK+HTC Frame) and may have a value of ‘2’ at a calibration position.

Upon receiving the sounding PPDU 504/506/508 from the user STA1/STA2/STA3, the AP transmits a frame 510 including CSI request information and sounding information to the user STA1/STA2/STA3. Herein, the frame 510 may be a QoS Null+HTC frame and may have a value of ‘3’ at a calibration position.

Upon receiving the frame 510, the user STA1/STA2/STA3 transmits a response frame (ACK frame) 512/514/516 to the AP in response to the frame 510. Herein, the response frame 512/514/516 may be transmitted to the AP at the transmission time point of the user STA1/STA2/STA3 included in scheduled response transmission information.

The user STA1/STA2/STA3 measures CSI of a channel directed from the AP to user STA1/STA2/STA3 by using the sounding information received from the AP through the frame 510, and transmits a frame 518/522/526 including the measured CSI. Herein, as illustrated in FIG. 5, the user STA1/STA2/STA3 may obtain a channel through a contention-based channel access method, transmit the frame 518/522/526 including the CSI measured by the user STA1/STA2/STA3 to the AP, and receive a response frame 520/524/528 from the AP with respect to the frame 518/522/526. In a modified embodiment, as illustrated in FIG. 5, the user STA1/STA2/STA3 may measure the CSI by using the sounding information received through the frame 510, and transmit the response frame 512/514/516 including the measured CSI to the AP in response to the frame 510.

The AP may simultaneously transmit data to the user STA1/STA2/STA3 by using the CSI 518/522/526 received from the user STA1/STA2/STA3 and the CSI of a channel for the user STA1/STA2/STA3 measured using the sounding PPDU 504/506/508 received from the user STA1/STA2/STA3. For example, the AP may calculate a beamforming matrix by using the CSI 518/522/526 received from the user STA1/STA2/STA3 and the CSI of a channel for the user STA1/STA2/STA3 measured using the sounding PPDU 504/506/508 received from the user STA1/STA2/STA3, and simultaneously transmit beamformed data to the user STA1/STA2/STA3 by using the calculated beamforming matrix.

The use of implicit feedback is based on FIG. 4 (a). The AP transmits the sounding PPDU request frame 502 to the user STA1/STA2/STA3, receives the sounding PPDU 504/506/508 from the user STA1/STA2/STA3, and measures the CSI of each channel directed from the user STA1/STA2/STA3 to the AP by using the sounding information included in the sounding PPDU 504/506/508. The AP simultaneously transmits beamformed data to the user STA1/STA2/STA3 by using the measured CSI of each channel. Herein, the frames 502, 504, 506 and 508 are the same as described above.

The use of explicit feedback is based on FIG. 4 (b). The AP transmits the frame 510 including the CSI request information and the sounding information to the user STA1/STA2/STA3, and obtains the CSI of a channel for the user STA1/STA2/STA3 by exchanging the frames 512, 514, 516, 518, 520, 522, 524, 526 and 528 with the user STA1/STA2/STA3. Also, as in the modified embodiment of FIG. 5, the user STA1/STA2/STA3 may transmit the response frame 512/514/516 about the frame 510, including the CSI measured using the sounding information received through the frame 510, to the AP. In both cases, the AP simultaneously transmits the beamformed data to the user STA1/STA2/STA3 by using the CSI of each channel. Herein, the AP may directly obtain a beamforming matrix from the user STA1/STA2/STA3, and transmit beamformed data to the user STA1/STA2/STA3 by using the beamforming matrix.

The sounding process in the MU-MIMO includes the TRQ information in the MU-MIMO frame including information about the MU-MIMO receivers, and it may be performed by a response process thereof. The response sounding frames 504, 506 and 508 to the TRQ request 502 must be transmitted in a predetermined sequence. The reason for this is that the ACK policy of the QoS Null+HTC frame including the TRQ information is a normal ACK type. The ACK frame structure includes only a receiving address (RA) without including a transmitting address (TA). Therefore, the AP having transmitted the TRQ 502 must explicitly know the sequence of the response frame 504/506/508 transmitted by the STA STA1/ATA2/STA3, in order to recognize the STA STA1/ATA2/STA3 having transmitted the sounding PPDU 504/506/508. This is also required in the case where TRQ information is carried in an RTS (Request To Send) frame and sounding information is carried in a CTS (Clear To Send) frame without a TA in response to the RTS frame.

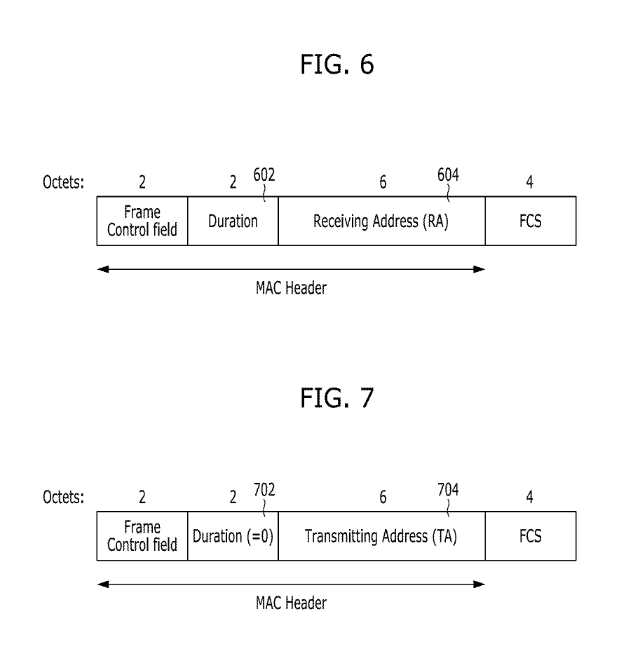

FIG. 6 illustrates a CTS/ACK frame structure defined in the IEEE 802.11. The CTS/ACK frame is a control response frame about the previous frame, and may include a frame control field, a duration field 602, an RA field 604, and a frame check sum (FCS) field. The CTS/ACK frame includes only an RA field 604 because it is transmitted after an SIFS time from the reception of the previous frame, in which other terminals cannot obtain a wireless channel.

Thus, if a response frame including sounding information in an MU-MIMO system is a response frame without a TA (e.g., a CTS/ACK frame), the sequence of a response frame is the only way to recognize the terminal transmitting the response frame, which may degrade the network performance or cause other problems in a wireless channel-sharing environment. Thus, a response frame structure is provided to recognize the terminal transmitting the response frame including the sounding information. Referring to FIG. 7, a response frame including sounding information in accordance with an exemplary embodiment of the present invention may include a frame control field, a duration field 702, an RA field 704, and an FCS field. Herein, the duration field 702 is set to ‘0’, and the RA field 704 includes transmitter information (e.g., TA).

A CTS frame including sounding information will be described below. The CTS frame in the MAC protocol defined in the IEEE 802.11 is a response frame to an RTS frame, and it operates in the order of ‘RTS-(SFIS)-CTS-(SIFS)-DATA MPDU-(SIFS)-ACK’ or in the order of ‘CTS-to-Self-(SIFS)-DATA MPDU-(SIFS)-ACK’. Thus, the value of the duration field 602 of the CTS frame for protection of a NAV (Network Allocation Vector) always has a value greater than 0. Thus, the value of the duration field 702 of the CTS frame including the sounding information may be set to ‘0’. Accordingly, if the value of the duration field 702 is ‘0’, the terminal having received the CTS frame including the sounding information knows that the value of the RA field of the CTS frame is the TA 704, and can recognize the terminal having transmitting the corresponding CTS frame.

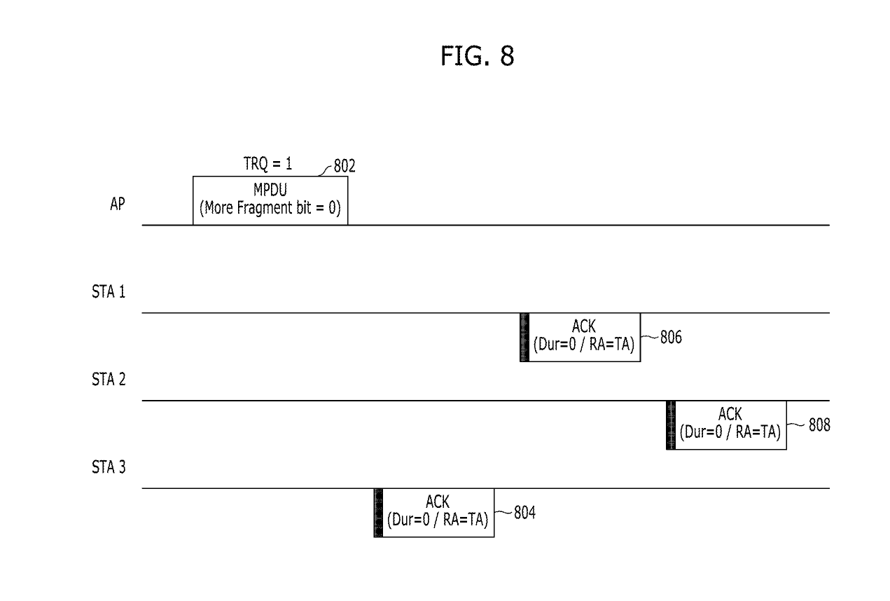

An ACK frame including sounding information will be described below. If a more fragment bit of a received MPDU (MAC Protocol Data Unit) is ‘0’, a non-QoS STA sets the duration field 602 of the ACK frame (i.e., a response frame thereof) to ‘0’. Herein, a QoS STA means a STA supporting IEEE 802.11e and a MAC function defined thereafter (e.g., IEEE 802.11e), and a non-QoS STA means a STA supporting only a legacy MAC function defined before IEEE 802.11e. The RA field 604 of the ACK frame (legacy ACK frame) transmitted by the non-QoS STA includes a receiving address. Thus, it is necessary to discriminate between the legacy ACK frame having the duration field 602 set to ‘0’ and the ACK frame in accordance with the present invention. In the calibration exchange process illustrated in FIG. 5, the ACK frame including the sounding information and having the duration field 702 set to ‘0’ a +HTC frame including an HT control field. Since a calibration position field has a value of ‘2’, it is discriminated from the legacy ACK frame having the duration field 602 set to ‘0’. The use of the ACK frame in the sounding process using implicit feedback in accordance with an exemplary embodiment of the present invention is illustrated in FIG. 8. Referring to FIG. 8, when the AP transmits an MPDU 802 including TRQ information to the STA STA1/STA2/STA3, the STA STA1/STA2/STA3 transmits a response frame 804/806/808 including sounding information to the AP in response to the MPDU 802. Herein, the duration field 702 of the response frame 804/806/808 is set to ‘0’, and a transmitting address is carried in the RA field 704. The AP receiving the ACK frame 804/806/808 including the sounding information from the STA STA1/STA2/STA3 can determine that the RA field includes the transmitting address (TA) in accordance with the present invention if the duration field 702 is ‘0’, because it already knows, in an association process, the fact that th STA transmitting the ACK frame is not a non-QoS STA.

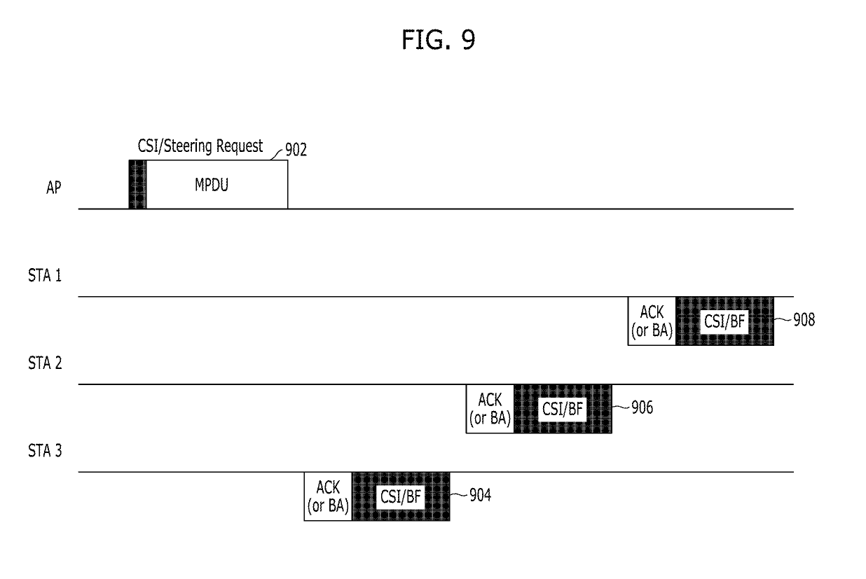

A method for the AP to transmit a frame 902 including CSI request information and sounding information and receive CSI from the user STA1/STA2/STA3, in the sounding process using explicit feedback or in a calibration process for implicit feedback, does not use EDCA and may aggregate the CSI in an MU-MIMO ACK frame 904/906/908, as illustrated in FIG. 9. In this case, the duration field 702 of the ACK frame 904/906/908 including the CSI may be set to ‘0’, and the transmitting address may be carried in the RA field 704.

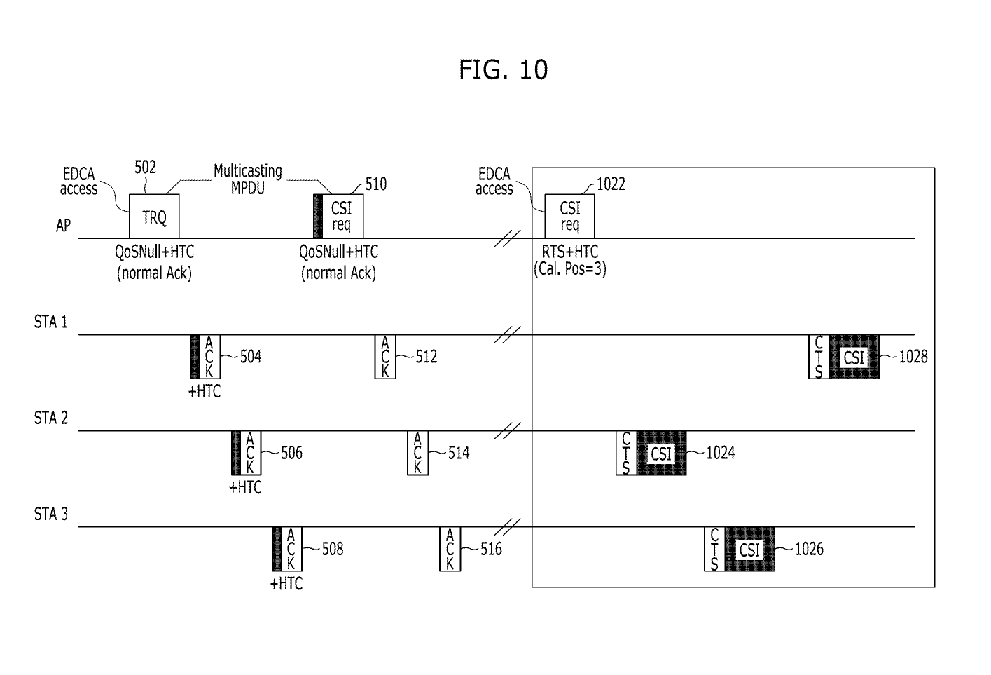

When transmitting the frame 518/522/526 including the CSI as illustrated in FIG. 5, the AP in FIG. 10 first transmits an RTS+HTC frame 1022 including CSI request information to the user STA1/STA2/STA3 in order to reduce a backoff overhead using EDCA. Herein, the RTS+HTC frame 1022 may carry scheduled response transmission information. The RTS+HTC frame 1022 does not include sounding information (signal). However, a calibration position value is set to ‘3’ to specify that the CSI request was made in the previous calibration, and the aggregated CSI is transmitted to the AP together with a CTS frame 1024/1026/1028 in response thereto. In this case, the duration field 702 of the CTS frame 1024/1026/1028 including the CSI information may be set to ‘0’, and the transmitting address may be carried in the RA field 704.

Thus, the control response frame including the transmitter information in accordance with the present invention can be used in the sounding process in the calibration process, in the sounding process using implicit feedback, and in the sounding process using explicit feedback. Also, in order to recognize the STA transmitting the CSI or the sounding information, the first method of transmitting the sounding information or CSI request frame including the scheduled response transmission information and the second method of using the control response frame (e.g., CTS and ACK) including the transmitter information may be implemented separately or together.

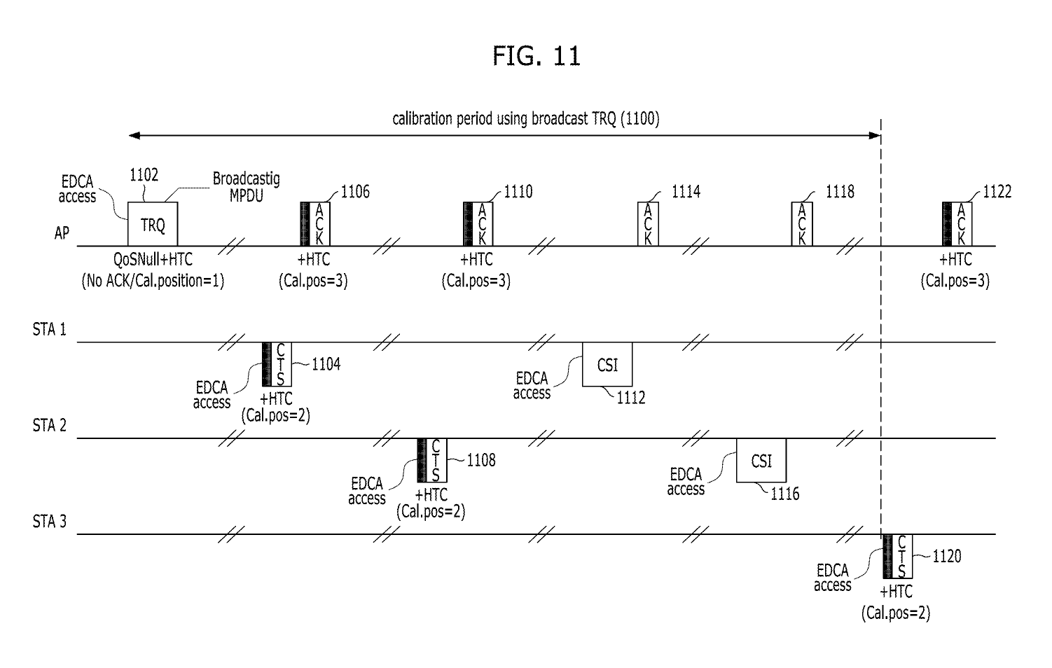

In the above sounding method, the AP transmits a request frame including TRQ information to one or more STAs to which data will be simultaneously transmitted. That is, one or more STAs transmit a response according to the scheduled response transmission information of multiple receivers included in the request frame. The frame including the TRQ information may be transmitted by multicast or by broadcast, which will be described below. A calibration process for implicit feedback using a broadcast scheme will be described below with reference to FIG. 11.

Referring to FIG. 11, the AP transmits a frame 1102 having a broadcast address and including TRQ information. That is, the AP broadcasts a request frame 1102 including TRQ information. Like the frame 502 of FIG. 5, the frame 1102 is a QoS Null+HTC frame and may have a value of ‘1’ at a calibration position as a calibration start frame. The frame 1102 does not include scheduled response transmission information, but has a broadcast address. Therefore, all the STAs capable of receiving a frame broadcasted from the AP receive the frame 1102.

Among the STAs having received the frame 1102, the STA STA1/STA2/STA3 desiring to receive data from AP transmits a response frame (e.g., a CTS frame) 1104/1108/1120 including sounding information. Herein, the MU-MIMO CTS sounding frame 1104/1108/1120 of ‘duration (702)=0 and RA field (704)=TA’ is transmitted through the channel access of EDCA, instead of being transmitted after an SIFS from the reception of the previous frame. The CTS frame 1104/1108/1120 including the sounding information may have a value of ‘2’ at a calibration position. The calibration process may be performed using ACK frames 1106 and 1110 and CTS sounding frames 1104 and 1108 received within a predetermined time (a calibration period using a broadcast TRQ (1100)). The response ACK frames 1106/1110 to the CTS sounding frames 1104 and 1108 include CSI request information and sounding information and have a value of ‘3’ at a calibration position.

The STA STA1/STA2 measures the CSI of a channel directed from the AP to the STA STA1/STA2 by using the sounding information received from the AP, and transmits a frame 1112/1116 including the measured CSI to the AP. Herein, the frame 1112/1116 including the measured CSI to the AP is transmitted to the AP through the channel access scheme of EDCA, and the AP transmits a response frame 1114/1118 to the STA STA1/STA2 in response to the frame 1112/1116. This is the same as described with reference to FIG. 5. However, since the STA3 transmits the CTS frame 1120 including the sounding information to the AP after a predetermined time 1100, the AP does not transmit an ACK frame 1122 in response thereto or transmits an ACK frame 1122 not including the CSI request information and the sounding information, thereby discarding the CTS frame 1120 received after a predetermined time 1100.

A sounding process is performed whenever the AP broadcasts a frame including a TRQ. Therefore, it is necessary to discriminate between the sounding processes. Thus, the frame 1102 including the broadcasted TRQ is given a token, and the token given to the frame 1102 is used in the sounding process performed according to the frame 1102. The AP detects the order of a sounding process through the token included in the CTS frame received from each STA, and discards the CTS frame received after a predetermined time (a calibration period using a broadcast TRQ) in the sounding process.

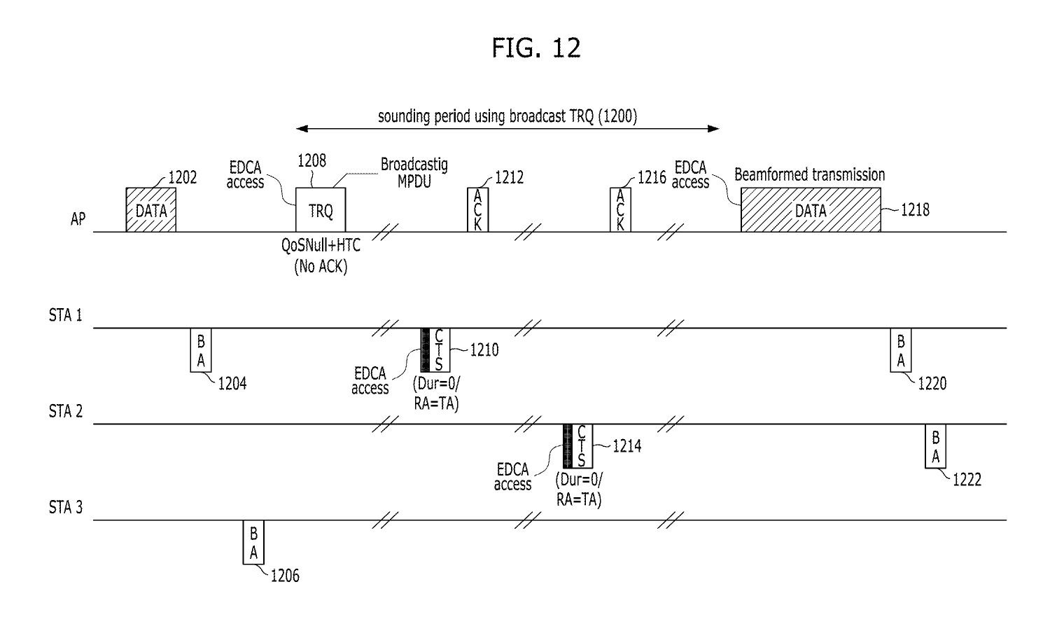

A sounding method for broadcasting a frame including TRQ information in accordance with another exemplary embodiment of the present invention will be described below with reference to FIG. 12. FIG. 11 illustrates a calibration process for implicit feedback, and FIG. 12 illustrates a sounding process using implicit feedback. Thus, a description of an overlap with FIG. 11 will be omitted for conciseness.

Referring to FIG. 12, the AP broadcasts a request frame 1208 including TRQ information in order to detect a STA that desires to receive beamformed data 1218 or has a channel change in a beamformed data transmission process 1202/1204/1206. Within a predetermined time 1200 in the sounding process, the STA STA1/STA2 transmits a CTS frame 1210/1214 including sounding information to the AP through EDCA and the AP transmits a response frame 1212/1216 to the STA STA1/STA2 in response to the CTS frame 1210/1214. The AP measures the CSI of a channel for the STA STA1/STA2 by using the sounding information obtained within the predetermined time 1200 in the sounding process, and transmits beamformed data 1218 to the STA STA1/STA2 by using the measured CSI.

In the case of broadcasting the request frame including the TRQ frame, the duration field 702 of a response frame (e.g., a CTS or ACK frame) including CSI or sounding information is set to ‘0’ and a TA value is included in the RA field 704, thereby enabling the AP to recognize the STA transmitting the response frame.

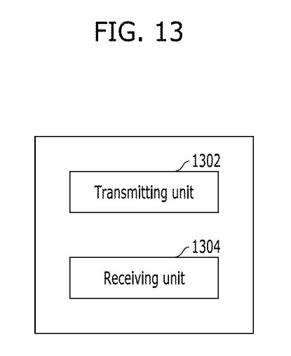

A configuration of an AP or an STA exchanging frames according to the above sounding method will be described below with reference to FIG. 13. A description of an overlap with the above description will be omitted for conciseness.

Referring to FIG. 13, an AP or an STA exchanging frames according to the above sounding method includes a transmitting unit 1302 and a receiving terminal 1304.

The transmitting unit 1302 transmits frames to a receiving terminal according to the above method, and the receiving unit 1304 receives frames from a transmitting terminal according to the above method.

In accordance with the exemplary embodiments of the present invention, channel state information (CSI) about each user can be obtained to provide a high throughput in a wireless communication system that simultaneously transmits data to multiple users. The present invention provides a frame exchange scheme for multiple users to overcome a performance limitation caused when using a sounding signal exchange sequence for a single user. Also, the present invention provides a structure that is efficient in applying a power control function and a compatibility function. Also, the present invention can implement an MU-MIMO technique dynamically according to services, thus making it possible to support various services and improve the system throughput.

While the present invention has been described with respect to the specific embodiments, it will be apparent to those skilled in the art that various changes and modifications may be made without departing from the spirit and scope of the invention as defined in the following claims.

What is claimed is:

1. A sounding method of a transmitting terminal that is to simultaneously transmit data to two or more receiving terminals in a wireless communication system, comprising:
transmitting a frame for requesting transmission of first sounding information to the two or more receiving terminals;
receiving a frame comprising the first sounding information from each of the two or more receiving terminals;
transmitting a frame comprising information for requesting transmission of channel state information and second sounding information to the two or more receiving terminals; and
receiving a frame comprising the channel state information, which is measured by each of the two or more receiving terminals by using the second sounding information, from each of the two or more receiving terminals,
wherein the channel state information measured by using the first sounding information and the channel state information received from each of the two or more receiving terminals are used to simultaneously transmit the data to the two or more receiving terminals.

2. The sounding method of claim 1, wherein
the frame for requesting the transmission of the first sounding information comprises one or more of information about an address of each of the two or more receiving terminals and information about a transmission time point of a response frame of each of the two or more receiving terminals; and
the response frame of each of the two or more receiving terminals comprises one or more of the frame comprising the first sounding information and the frame comprising the channel state information.

3. The sounding method of claim 1, wherein the frame comprising the first sounding information comprises a duration field of ‘0’ and an address of the receiving terminal transmitting the frame comprising the first sounding information.

4. The sounding method of claim 1, wherein the frame comprising the channel state information comprises a duration field of ‘0’ and an address of the receiving terminal transmitting the frame comprising the channel state information.

5. The sounding method of claim 1, wherein the frame for requesting the transmission of the first sounding information is transmitted by multicast or broadcast.

6. A sounding method of a receiving terminal that receives data from a transmitting terminal that is to simultaneously transmit data to two or more receiving terminals in a wireless communication system, comprising:
receiving a frame for requesting transmission of first sounding information from the transmitting terminal;
transmitting a frame comprising the first sounding information to the transmitting terminal;
receiving a frame comprising information for requesting transmission of channel state information and second sounding information from the transmitting terminal; and
transmitting a frame comprising the channel state information, which is measured by using the received second sounding information, to the transmitting terminal,
wherein the channel state information measured by the transmitting terminal by using the first sounding information and the channel state information measured by using the second sounding information are used to simultaneously transmit the data from the transmitting terminal to the two or more receiving terminals.

7. The sounding method of claim 6, wherein
the frame for requesting the transmission of the first sounding information comprises one or more of information about an address of each of the two or more receiving terminals and information about a transmission time point of a response frame of each of the two or more receiving terminals;
the response frame of each of the two or more receiving terminals comprises one or more of the frame comprising the first sounding information and the frame comprising the channel state information; and
the frame comprising the first sounding information or the frame comprising the channel state information is transmitted to the transmitting terminal according to the information about the transmission time point of the response frame of each of the two or more receiving terminals.

8. The sounding method of claim 6, wherein the frame comprising the first sounding information comprises a duration field of ‘0’ and an address of the receiving terminal transmitting the frame comprising the first sounding information.

9. The sounding method of claim 6, wherein the frame comprising the channel state information comprises a duration field of ‘0’ and an address of the receiving terminal transmitting the frame comprising the channel state information.

10. The sounding method of claim 6, wherein the frame for requesting the transmission of the first sounding information is transmitted by multicast or broadcast.

11. A sounding method of a transmitting terminal that is to simultaneously transmit data to two or more receiving terminals in a wireless communication system, comprising:
transmitting a frame comprising information for requesting transmission of channel state information and sounding information to the two or more receiving terminals; and
receiving a frame comprising the channel state information, which is measured by each of the two or more receiving terminals by using the sounding information, from each of the two or more receiving terminals,
wherein the channel state information received from each of the two or more receiving terminals is used to simultaneously transmit the data to the two or more receiving terminals.

12. The sounding method of claim 11, wherein
the frame comprising the information for requesting the transmission of the channel state information and the sounding information comprises one or more of information about an address of each of the two or more receiving terminals and information about a transmission time point of a response frame of each of the two or more receiving terminals; and
the response frame of each of the two or more receiving terminals comprises the frame comprising the channel state information.

13. The sounding method of claim 11, wherein the frame comprising the channel state information comprises a duration field of ‘0’ and an address of the receiving terminal transmitting the frame comprising the channel state information.

14. A sounding method of a receiving terminal that receives data from a transmitting terminal that is to simultaneously transmit data to two or more receiving terminals in a wireless communication system, comprising:
receiving a frame comprising information for requesting transmission of channel state information and sounding information from the transmitting terminal; and
transmitting a frame comprising the channel state information, which is measured by using the received sounding information, to the transmitting terminal,
wherein the channel state information measured by using the received sounding information is used to simultaneously transmit the data from the transmitting terminal to the two or more receiving terminals.

15. The sounding method of claim 14, wherein
the frame comprising the information for requesting the transmission of the channel state information and the sounding information comprises one or more of information about an address of each of the two or more receiving terminals and information about a transmission time point of a response frame of each of the two or more receiving terminals; and
the response frame of each of the two or more receiving terminals comprises the frame comprising the channel state information.

16. The sounding method of claim 14, wherein
the frame comprising the channel state information comprises a duration field of ‘0’ and an address of the receiving terminal transmitting the frame comprising the channel state information.

17. A transmitting terminal for performing sounding to simultaneously transmit data to two or more receiving terminals in a wireless communication system, comprising:
a transmitting unit configured to transmit a frame for requesting transmission of first sounding information to the two or more receiving terminals; and
a receiving unit configured to receive a frame comprising the first sounding information from each of the two or more receiving terminals,
wherein
the transmitting unit transmits a frame comprising information for requesting transmission of channel state information and second sounding information to the two or more receiving terminals;
the receiving unit receives a frame comprising the channel state information, which is measured by each of the two or more receiving terminals by using the second sounding information, from each of the two or more receiving terminals; and
the channel state information measured by using the first sounding information and the channel state information received from each of the two or more receiving terminals are used to simultaneously transmit the data to the two or more receiving terminals.

18. The transmitting terminal of claim 17, wherein the frame comprising the first sounding information comprises a duration field of ‘0’ and an address of the receiving terminal transmitting the frame comprising the first sounding information.

19. A receiving terminal for performing sounding to receive data from a transmitting terminal that is to simultaneously transmit data to two or more receiving terminals in a wireless communication system, comprising:
a receiving unit configured to receive a frame for requesting transmission of first sounding information from the transmitting terminal; and
a transmitting unit configured to transmit a frame comprising the first sounding information to the transmitting terminal,
wherein
the receiving unit receives a frame comprising information for requesting transmission of channel state information and second sounding information from the transmitting terminal;
the transmitting unit transmits a frame comprising the channel state information, which is measured by using the received second sounding information, to the transmitting terminal; and
the channel state information measured by the transmitting terminal by using the first sounding information and the channel state information measured by using the second sounding information are used to simultaneously transmit the data from the transmitting terminal to the two or more receiving terminals.

20. The receiving terminal of claim 19, wherein the frame comprising the first sounding information comprises a duration field of ‘0’ and an address of the receiving terminal transmitting the frame comprising the first sounding information.
